(19) United States
(12) Patent Application Publication
(10) Pub. No.: US 2009/0269602 A1
(43) Pub. Date: Oct. 29, 2009

(54) ADHESIVE SYSTEM AND WOOD BASED PANELS WITH LOW SUBSEQUENT FORMALDEHYDE EMISSION AND SUITABLE PRODUCTION PROCEDURE

(75) Inventors: Manfred Dunky, St. Polten (AT); Kristina Durkic, Lillestrom (NO); Gunnar Andersen, Lovenstad (NO)

Correspondence Address: BIRCH STEWART KOLASCH & BIRCH, PO BOX 747, FALLS CHURCH, VA, 22040-0747, US

(73) Assignee: Dynea Oy, Helsinki (FI)

(21) Appl. No.: 12/439,489

(22) PCT Filed: Aug. 30, 2007
(86) PCT No.: PCT/IB2007/002508

§ 371 Date: Apr. 2, 2009

Related U.S. Application Data
(60) Provisional application No. 60/824,271, filed on Aug. 31, 2006.

(51) Int. Cl. B32B 21/08; B05D 3/10; B05D 1/36

(52) U.S. Cl. 428/528; 427/301; 427/408

(57) ABSTRACT

Particle or MFD boards are disclosed comprising an aminoplastic resins and yet exhibiting low emissions levels of formaldehyde, as well as methods to arrive at such boards.

### CROSS-REFERENCE TO RELATED APPLICATION

This application claims priority of U.S. Provisional Application No. 60/824,271, filed on Aug. 31, 2006, the entire contents of which are hereby incorporated by reference.

### FIELD OF THE INVENTION

The present invention relates to efficient methods for producing boards, such as MDF and particleboards, which emit low levels of formaldehyde and have desirable physical properties.

### BACKGROUND OF THE INVENTION

Previously known MDF and particleboard having favorable physical properties, such as standard European E1 boards, were made with urea formaldehyde (UF) based adhesive resins having relatively high formaldehyde: urea ratios (F/U). Although boards made with high F/U ratio resins have good mechanical strength, water resistance, water absorption, hardness, favorable processing characteristics etc. are known, such boards have unfavorable levels of formaldehyde emission.

The emission of formaldehyde from wood-based boards and panels bonded with formaldehyde-based adhesive resins is a known phenomenon caused by the release from finished boards residual unbonded formaldehyde and by the hydrolysis of weakly bonded formaldehyde in the hardened resin, a phenomena also known as subsequent formaldehyde emission.

The subsequent formaldehyde emissions of aminoplastic bonded boards are mainly influenced by the formaldehyde: urea molar ratio (F/U) of the resin, or by the formaldehyde:NH₂ molar ratio (F/(NH₂)₂ of the resin when other amino containing components are present in the adhesive resin. In general, the lower the F/U or (F/(NH₂)₂ molar ratio of an aminoplastic resin, the lower the subsequent formaldehyde emission of the finished board. The subsequent formaldehyde emission has been described extensively in the technical and chemical literature, see e.g. M. Dunky and P. Niemz, “Holzwerkstoffe und Leime” (Wood based panels and resin adhesives), Springer, 2002.

Given the adverse health consequences associated with formaldehyde, there has been a need and a movement to limit the amount of formaldehyde emissions from finished board products. For instance, Japan has developed the F**** quality standards (sometimes also referred to as “Super E Zero”), JIS A 5908 (for particleboards) and JIS A 5905 (for MDF), which are described in Table 1.

TABLE 1
Japanese Board Quality Standards

| | | | Upper | Alternative upper |
|---|---|---|---|---|
| Board | | | limit of | limit (not stated |
| quality | Standard | Test method | emission | in standard) |
| F**** | JIS A 5905 | Desiccator | ≦0.3 mg/l | Perforator value: |
| | JIS A 5908 | Test JIS A | | approx. 2 mg/100 g |
| | | 1460 | | absolutely dry board |
| | | | | for particleboard and |
| | | | | 3-4 mg for MDF |

Conventionally, low emission MDF and particleboard products, such as boards that comply with F**** standards, can be manufactured using phenolic, aminoplastic and isocyanate resins. The amount of emittable formaldehyde of phenolic resins is low due to their good hydrolytically resistance. Usually, aminoplastic resins adjusted to have a low F/(NH₂)₂ molar ratio, typically with urea, often in the range of 0.70 to 0.98 or 0.80 to 0.90, are used to manufacture finished MDF and particleboard products that emit low levels of formaldehyde, for instance formaldehyde emissions that comply with F**** standards as defined in Table 1.

The main disadvantages of known production procedures for boards having low formaldehyde emissions, as compared to standard E1 boards having good physical and production properties, may be largely classified within three areas that increase costs and/or decrease production efficiency: (i) the use of higher resin loading and additional and/or more specialized chemicals, (ii) increase in the board density and (iii) and increased press times.

In regard to the increase in the resin loading, resins with low F/NH₂ molar ratios have lower crosslinking potential so a greater amount of the resin is necessary to achieve the required grade of cross-linking. In regard to additional and/or specialized chemicals, formaldehyde catchers/scavengers/scavenger chemicals that react with formaldehyde and might therefore decrease formaldehyde emission generally increase price. Similarly, it is known that melamine fortified urea formaldehyde (mUF) resins are more expensive due to the higher costs for melamine as raw material. The same is the case with other modified resin adhesives as well as with phenolic and isocyanate resins.

In regard to dry wood material (fibres or particles or other structural elements) content of adhesive resins with boards having low subsequent formaldehyde emissions, a higher content of dry wood material is typically required due to the reduced crosslinked state of the hardened resin adhesives having lower F/U or F/(NH₂)₂ molar ratio, as is the case for aminoplastic condensation resins. Here, increased board density will improve board properties, but will entail an increase of all solid materials and, perhaps, production cost.

In regard to increased press times associated with the production of low emission formaldehyde boards, disadvantages are expressed as movement of the press belt in a continuous line (in mm/s) or press time (seconds) or specific press time (seconds/mm) when based on the thickness of the board. This area of disadvantage is typical for all types of resins, as compared to the standard E1 boards. Aminoplastic resins show an increased necessary hardening time with a lower content of formaldehyde.

Disadvantages of low formaldehyde emitting phenoplastic resins include their lower reactivity, as compared to standard UF-E1 resins, which causes a significant increase in press time as well as a risk of higher moisture uptake. In addition, the price of phenoplastic resins is at least double that of standard UF resins.

In regard to a comparison of standard E1 board bonded with a straight UF resin, the adhesive unit prices (always indicated in figures based on solids) of melamine-fortified low F/(NH₂)₂ molar ratio resins are 30 to 70% higher for aminoplastic resins, depending on the melamine content of the adhesive resin, and 5-6 times higher for isocyanate based adhesives. The approximate increase in adhesive consumption (expressed as % adhesive solids/dry furnish), necessary to arrive at fair quality boards having low subsequent formaldehyde emissions is plus 10-20% for aminoplastic resins; whereas the adhesive consumption for isocyanate is not directly comparable with UF resins. The increase in press time, as compared to standard E1 resins, is up to about plus 20% for melamine fortified resins.

Hybrid systems of aminoplastic and isocyanate resins have been described in the technical and patent literature (see M. Dunky and P. Niemz, “Holzwerkstoffe und Leime” (Wood based panels and resin adhesives, Springer, 2002), where the isocyanate component acts as an additional cross-linker for the aminoplastic adhesive resin, which itself has an extremely low content of formaldehyde. The UF resin alone, without this fortification by the isocyanate component, would have inferior mechanical strength and other physical properties, such as hardness, moisture resistance, thickness swelling, etc. The disadvantages of this hybrid system include the increased effort associated with the use of two different adhesives, which must be stored, dosed separately and mixed with each other prior to blending, together with all the necessary requirements concerning environmental, safety and health protection associated with using isocyanates as well as the high cost of isocyanate.

Several methods exist for the post-treatment of boards to produce low subsequent formaldehyde emission boards, such as an ammonia treatment or a treatment with urea and ammonia producing compounds. But these methods are rarely used today. A comprehensive summary of such methods is given by G. E. Myers: Effects of post-manufacture board treatments on formaldehyde emission: a literature review (1960-1984), Forest Products Journal 36 (1986) 6, 41-51.

An exemplary list of previously known, low subsequent formaldehyde emission boards and board production methods from the patent and technical literature include the following:
U.S. Pat. No. 5,681,917 discloses a storage-stable, low mole ratio melamine-urea-formaldehyde resin, giving low formaldehyde emission on curing, which can be used as adhesive for the production of composite board products.
EP0643085A discloses a water-insoluble condensation resin with a low formaldehyde emission, and this resin is prepared by reacting formaldehyde with a mixture of melamine, substituted melamine, optionally methylolated polyurea, and optionally a phenolic compound.
The publication DD0300296A discloses a urea-formaldehyde resin with both low formaldehyde emission and high reactivity. This resin is prepared by condensation of urea with formaldehyde at an acidic pH that is then submitted to alkaline pH, and after that, more urea is been added.
EP0322297A discloses method for preparing a urea-formaldehyde resin that contains melamine. This resin is described as useful for the production of chipboard panel with low formaldehyde emission.
U.S. Pat. No. 4,536,245 discloses urea-melamine-formaldehyde adhesive resins useful e.g for the production of particleboards of low formaldehyde emission after curing.
EP0038408A discloses the reduction of the formaldehyde release out of UF-bonded wood products achieved by the addition of a mixture of urea, melamine and ammonium sulphate to the binder.
EP0025245A discloses the use of an aminoplastic resin of specified low molar ratio of formaldehyde to amino and polyisocyanate as additional cross linker for the manufacturing of particleboards with low formaldehyde emission. Suitable mechanical and physical properties of the boards can only be achieved when combining these two types of adhesives, i.e. the aminoplastic with low contribution to the formaldehyde emission and the polyisocyanate.

### BRIEF SUMMARY OF THE INVENTION

The present invention relates to efficient methods for producing MDF and particleboards having low subsequent formaldehyde emissions and desirable physical and production properties, as compared to standard E1 boards.

### DETAILED DESCRIPTION OF THE INVENTION

### 1. Definitions

Aldehyde condensation resin: A resin obtained by condensation between an aldehyde, such as formaldehyde, and a monomer with functional groups, such as amino (urea, melamine) and hydroxyl (phenol) groups.

Aminoplastic resin: the term aminoplastic resin refers to amino group containing components including curable aldehyde condensation resins such as, for example, urea-aldehyde resins, aniline-aldehyde resins, melamine-aldehyde resins, mixtures of two of these resins, melamine-urea cocondensation-aldehyde resins, and the like. Optionally, a naturally occurring component or derivative thereof can be added or co-condensed into the resin, such as proteinaceous material, lignins, organic acid, fatty acid and polyols (for example carbohydrates, starch and sugars). The naturally occurring component or derivative thereof can be vegetable or animal based. Preferably, the naturally occurring component or derivative thereof is a proteinaceous material (i.e., a material comprising protein).

Core layer: The core layer is the centre part of a particleboard. The size of the wood particles are bigger than for the two surface layers. The core layer is by weight approximately 50-75% of a particleboard, the two surface layers together are the remaining 50-25% by weight.

E1 boards (Standard): Wood based panels can be categorized by their ability to emit formaldehyde. The so-called “E1” quality is defined in the will known European standards EN 312, EN 622 and EN 300.

EN standard 312: The EN-312 standard specifies the requirements for resin-bonded unfaced particleboards. There are 7 classes and the particleboards in accordance with the standard may be referred to as P1 to P7 boards. Property, test methods and requirements are connected to each of the 7 classes.

EN 319 test method: The EN 319 test method determines the tensile strength perpendicular to the plane of particleboard and fibreboard.

EN standard 622-5: The EN 622-5 standard specifies the formaldehyde emissions requirements for MDF fibreboards produced according to the dry method.

EN 717-1 climate chamber test: EN 717-1 is a standardised method for determining formaldehyde release from wood based panels. The EN 717-1 standard describes three options of test chambers for the determination of the formaldehyde emission from wood based panels in terms of the steady state concentration in a climate chamber under defined conditions, which relate to average conditions in real life. Defined conditions are: volume of chamber, loading factor, air exchange rate air velocity, air temperature and humidity and definition of steady state. The emission value, concentration of formaldehyde obtained under steady state in the chamber, is expressed by mass to volume in milligrams formaldehyde per cubic meter air (mg/m³).

Environmental Sign UZ 38: The environmental sign UZ 38 defines formaldehyde emissions for finished products for indoor use, such as furniture, interior doors and panels. The upper formaldehyde emission limits are for raw boards is a steady state concentration of 0.1 ppm (corresponding to a perforator value of 4.5 mg/100 g dry board). For finished boards, the steady state formaldehyde emission concentration must be below 0.05 ppm (corresponding to a gas analysis according to EN 712 of 2.0 mg/hr*m2).

Environmental Sign UZ 76: The environmental sign UZ 76 is also called “Blue Angel,” and it refers to a steady state formaldehyde emission limit of 0.05 ppm for raw and finished boards.

F****: The term “F****” as presently used is synonym for boards with a subsequent formaldehyde emission, which is much lower than the well-known E1 class and even distinctly lower than for some special boards available as niche products like boards according to the Environmental Sign UZ 38 or UZ 76. For the evaluation and classification of boards with such low subsequent formaldehyde emission, the methods and limits described in the Japanese standards JIS A5908 for particleboards and JIS A5905 for MDF can be used. These limits refer to the so-called Desiccator test according to JIS A 1460; and the so-called F**** limit for the subsequent formaldehyde emission in the standards mentioned above is 0.3 mg/l. Another suitable measure to describe and define the subsequent formaldehyde emission of boards with low subsequent formaldehyde emissions as aimed at by the present invention can be the steady state concentration in a climate chamber according to EN 717-1, under which a suitable limit for classifying boards with low emission is 0.3 ppm. There might also exist other methods and corresponding limits for boards with such low subsequent formaldehyde emission as described herein, partly based on other test methods in other countries and continents, but also suitable to distinguish clearly to the standard “E1” boards as mentioned above.

Formaldehyde emission: The term formaldehyde emission can be described as the actually emitted amount of formaldehyde, e.g. as the concentration of formaldehyde in a climate chamber, or as the emittable potential of formaldehyde in the board. These two different mechanisms have not only resulted in various and partly very different test methods which have been developed over the last decades, but also in two different basic approaches with respect to how to characterize (i) the formaldehyde content as potential emittable formaldehyde, and (ii) the effective emission out of the boards. This distinction is important, because the two approaches consider the various sources of formaldehyde in a board in a different way. In the so-called “perforator test” the total content of free (emittable) formaldehyde in the board is measured, not considering if at all and if so, at which rate (i.e. amount per time, based on a certain surface area) this emission will take place. Upon neglecting in a first approximation the emission behaviour out of the edges—which based on the same area is distinctly higher, but the contribution of the edge areas to the overall area is usually is rather small—the emission mainly takes place via the surface layer of the board. This means that for example the emittable formaldehyde in the surface layer of three layer boards (in the outer layers of a single layer board) must be seen as different to the emittable formaldehyde in the core/inner layer.

Formaldehyde catcher or scavenger: A formaldehyde catcher or scavenger is a substance that can reduce the formaldehyde content or emission from the finished board. The substance is added in the production process or on the boards afterwards.

Gel time: Gel time, as used herein, is the time taken for a resin solution to go from the liquid state to the gel state. The point of transition is called the gel point. At the gel point there is an abrupt change in the physical properties of the resin, for example the viscosity and molecular weight.

Glue kitchen: Glue is mixed with hardener, water, wax emulsion, urea, ammonia, scavenger and/or other additives before it is applied to the chips or fibres. This mixing, dosing control etc is done in a glue kitchen.

Hardener: A hardener is an agent added to the glue mix or separate in the blender to speed up the reaction/gelation of a glue. Hardener for particleboard and MDF is often an ammonium salt, Am-chloride, Am-nitrate or Am-sulphate. Ammonium reacts with formaldehyde, pH will drop and the glue reacts faster. Weak acids can also be used as hardener.

Hot press cycle: Hot press cycle or a press cycle, is a measure, in units of seconds per mm board thickness, of the rate of pressing resin based boards or panels in continuous line production.

Internal bond strength: Internal bond strength is a determination of the strength perpendicular to the plane of the board, described in test method EN 319.

JIS A 1460 desiccator test: JIS A 1460 desiccator test: JIS A 1460 is a Japanese standardized method to determine formaldehyde release from wood based panels. The method is also known as the desiccator method.

JIS standard JIS A 5905. The known Japanese standard JIS A5905 applies to MDF. This standard classifies MDF according to strength and formaldehyde emission properties.

JIS standards A5908: The known Japanese standard JIS 5908 applies to particleboard obtained from hotpressing of wooden particles with adhesives. This standard classifies particleboard according to strength and formaldehyde emission properties.

Mechanical strength: Mechanical strength properties describe the strength of a particleboard or MDF board. Defined test methods are used to determine the strength value, often in N/mm². For classification of particleboard and MDF a set of minimum mechanical strength is required for the different classes. IB, MOR and MOE is defined as mechanical properties in EN 312 and EN 622-5.

Mat forming station: A mat forming station comprises equipment or installation that can spread out or lay out resinated particleboard chips in one or more layers before the mat goes into the hot press.

Premixed resins: A resin that is mixed with hardener or other additives before applied to the chips (particleboard) or in the blow line or blender (MDF).

Press speed: The term press speed describes the time necessary to convert the resinated furnish into a mechanically stable board that can leave the press. The press speed is mainly influenced by the temperature and pressure profile of the board production process, the reactivity of the resin—catalyst combination, the pH and buffer capacity of the wooden material, the type of press and its installation, etc.

Running performance: Running performance is a summarised opinion of how particle board or MDF processing is running. It is often used in connection with experimental resin in a test run. Such things as pressing time, number of off grade boards and all types of negative impacts are described.

Steam effect: The term “steam effect” as used herein describes how the manner of heat transfer from the hot press plates to resin based boards and panels with the help of moisture in the surface. Heat is transferred as steam that moves towards the centre of boards and panels in production. The amount of steam can be increased or decreased by controlling the moisture of surface chips going into the hot press.

Screw withdrawal strength: This term refers to a test method for determining how much strength is required to withdraw a crew from a particleboard or MDF.

Surface layer: The surface of a resin based board or panel: there are two surface layers per board or panel.

Thickness swelling: Thickness swelling describes how much a particleboard or MDF board swells after being stored in water for 24 hours. The increase in board thickness, or swelling, after the 24 hour water storage period is expressed in % relative to a board's pre-water storage period.

Water resistance: Water resistance particleboards and MDF must be tested according to specified test methods and fulfil specified requirements to be classified according to specified standards (for particleboard and MDF).

### 2. The Invention

It is an object of the present invention to provide methods for the production of boards with low subsequent formaldehyde emission (such as F**** compliant boards) at no or minimized increase in production complexity, efficiency and costs as compared to standard E1 boards. Another object of the present invention is to maintain the same running performance when producing F**** boards, again as compared to the production of standard E1 boards. Yet a further object of the present invention is to achieve the physical properties of finished boards as defined in the by standard E1 boards, but with distinctly lower subsequent formaldehyde emissions. The solution to these problems has now surprisingly been found by means of the present invention.

The present invention, therefore, provides in one aspect a multilayer, low-formaldehyde emission board comprising:

A) a core layer comprising a first adhesive composition, and

B) a face layer comprising a second adhesive composition;

wherein
1) each of said first and second adhesive compositions comprises an aminoplastic resin that has a dry base composition comprising between 0 and 15% melamine, and
2) said aminoplastic resin has a formaldehyde:NH₂ molar ratio (F/(NH₂)₂) of:
   a) between 0.60 and 1.05 when said resin comprises melamine, or
   b) greater than 0.85 when said resin is essentially free of melamine and when said resin comprises urea as well as other NH₂ containing components, and
3) said aminoplastic resin has a formaldehyde:urea molar ratio (F/U) of more than 0.85 when said resin is essentially free of melamine and comprises urea as the only NH₂ component;
4) said board emits:
   a) 0.5 mg/ml or less formaldehyde as measured in a Desiccator Test JIS A 1460, or
   b) 0.04 ppm or less formaldehyde as measured in an EN 717-1 climate chamber, and
5) said first and second adhesive compositions are not the same.

In another aspect, the present provides a multilayer, low-formaldehyde emission board comprising:

A) a core layer comprising a first adhesive composition, and

B) a face layer comprising a second adhesive composition;

wherein
1) each of said first and second adhesive compositions comprises an aminoplastic resin that has a dry base composition comprising between 0 and 15% melamine, and
2) the aminoplastic resin of said first adhesive composition:
   i) has a formaldehyde:NH₂ molar ratio (F/(NH₂)₂) of:
      a) between 0.65 and 1.15 when said resin comprises melamine, or
      b) greater than 0.60, alternatively greater than 0.70, alternatively greater than 0.85 when said resin is essentially free of melamine and when said resin comprises urea as well as other NH₂ containing components, and
   ii) has a formaldehyde:urea molar ratio (F/U) of more than 0.85 when said resin is essentially free of melamine and comprises urea as the only NH₂ component, and
3) the aminoplastic resin of said second adhesive composition has:
   i) a formaldehyde:NH₂ molar ratio (F/(NH₂)₂) of:
      a) between 0.6 and 0.9, when said resin comprises melamine, or
      b) greater than 0.60 when said resin is essentially free of melamine and when said resin comprises urea as well as other NH₂ containing components, and
   ii) a formaldehyde:urea molar ratio (F/U) of more than 0.60 when said resin is essentially free of melamine and comprises urea as the only NH₂ component, and
4) said board emits:
   a) 0.5 mg/ml or less formaldehyde as measured in a Desiccator Test JIS A 1460, or
   b) 0.04 ppm or less formaldehyde as measured in an EN 717-1 climate chamber, and
5) said first and second adhesive compositions are not the same.

Adhesives of the present invention can be used in various aspects of board production, including the core layer in three layer boards or in one of the core layers in multilayer boards, wherein the solids content of the aminoplastic resin or the glue mix as applied to the board is 64% or more, alternatively more than 68%, alternatively more than 69%, and less than 76%, alternatively less than 72%. Such boards can further comprise an aminoplastic resin comprising melamine at a level of not more than 12%, alternatively not more than 9%, and alternatively not more than 6%, on a dry resin basis.

In a further embodiment of the present invention, the aminoplastic resin of the core layer of the boards of the invention comprises melamine and wherein the F/(NH₂)₂ molar ratio is more than 0.80, alternatively more than 0.85, and less than 1.15, alternatively less than 1.08, alternatively less than 0.96. In the cases where the aminoplastic resin of the core layer is essentially free of melamine, and urea is essentially the only NH₂-group containing raw material of the resin, the F/U molar ratio is preferably more than 0.90, and alternatively more than 0.95. When the aminoplastic resin of the core layer is essentially free of melamine, and the resin comprises urea as well as other NH₂-group containing materials as raw materials, the F/(NH₂)₂ molar ratio is preferably more than 0.90, and alternatively more than 0.95.

In a further embodiment of the present invention, the aminoplastic layer of the surface resin comprises melamine in which the F/(NH₂)₂ molar ratio is more than 0.60, alternatively between 0.70 and 0.90, alternatively more than 0.70 and less than 0.86. In cases where the aminoplastic resin of the surface layer is essentially free of melamine and urea is essentially the only NH₂ group containing raw material of the surface layer resin, the F/U molar ratio is preferably more than 0.60, alternatively more than 0.70. When the aminoplastic resin of the surface layer is essentially free of melamine and the resin comprises urea as well as other NH₂ group containing materials as raw materials of the surface layer resin, the F/U molar ratio is preferably more than 0.60, alternatively more than 0.70.

The adhesive system may further comprise a catcher or scavenger; the catcher or scavenger preferably being urea or condensated chemical structures based on urea, or any other chemical compound being able to react with formaldehyde, preferably containing nitrogen. In the simplest way, this scavenger can be urea, added in the form of a powder, a prilled solid form, a particle before or after the dryer (i.e. before the blender), or added in the form of an aqueous solution, a slurry or a dispersion, but not limited to these examples. So-called condensated scavenger resins can be used instead of simple urea.

The catcher and scavengers of the invention may be added to the adhesive resin mix at various stages of the board production process. For instance, the catcher and scavengers of the invention may be mixed in with the resin: (i) in the so-called glue kitchen in a suitable mixing vessel; (2) by separately pumping until close to the place of the application like blender or blowline but then mixing before the application onto the particles or fibres by suitable means like a so-called static mixer or any other suitable device; or (iii) pumping and applying separately to the particles or fibres.

The use of premixed resins of various components is also envisaged by the present invention. Such premixes allow less water to be added to wood and/or cellulose particles during the blending process, when only one high solid component is used instead of several low solid components. In one embodiment, premixes can be used, consisting of one or several components out of the group of hardeners, accelerators, catchers and scavenger and other additives added during production. The use of premixes helps to decrease the moisture content of the core and hence to strengthen the so-called steam effect in order to heat up the core.

There are multiple embodiments of the aminoplastic resins of the present invention, including resins comprising a curable aldehyde condensation resin, and, optionally, further comprising melamine, urea or mixtures thereof. In another embodiment, the aminoplastic resin may be composed of two or more components, which are mixed during the resin production. In another embodiment, the aminoplastic resin of the invention may comprise two or more components, mixed during the board production process, and optionally added and applied partly or totally separately during the board production process.

When a board of the invention, preferably MDF or particle board, comprises at least one core layer, this core layer can comprise a first adhesive composition as described above, whilst two surface layers comprise a second adhesive composition as described above, but differing from the first adhesive composition. The first adhesive composition can comprise an aminoplastic resin, which is essentially free of melamine. The core layer can comprise an aminoplastic resin having a solids content on a dry basis of more than 64%, alternatively more than 68%, and less than 76%, alternatively less than 72%.

When the aminoplastic resin of any of the first or second adhesive composition is essentially free of melamine and urea is essentially the only NH₂-group containing raw material, the F/U molar ratio should be more than 0.90, alternatively more than 0.95. When the aminoplastic resin of any of the first or second adhesive composition is essentially free of melamine and urea as well as other NH₂-group containing raw materials are used as raw materials for the resin, the F/(NH₂)₂ molar ratio can be more than 0.85, alternatively more than more than 0.90, alternatively more than 0.95 and alternatively between 0.85 and 1.08.

Alternatively, the second adhesive composition comprises an aminoplastic resin comprising more than 0% but less than 15% of melamine, alternatively less than 12%, more alternatively less than 9%, and less than 6%, on dry resin basis. The F/(NH₂)₂ molar ratio in the second aminoplastic resin can be more than 0.60, alternatively more than 0.70, and less than 0.90, alternatively less than 0.86.

The catcher or scavengers of the invention, which can be urea or a molecule with a condensated chemical structure based on urea, or any other chemical compound being able to react with formaldehyde, may be applied to the boards and resins of the invention as liquid to the second resin composition. The catcher or scavenger can be applied to the surfaces before and/or after a mat forming step. When the process includes the application of a first and a second adhesive composition different from each other, either or both of these compositions can be mixed during the resin production or at the board production process or are applied partly or totally separately during various stages of the board production process.

In another aspect, the present invention provides a process for producing the above described boards, wherein said first and/or said second adhesive composition are composed of two or more components, which are (a) mixed during the resin production or (b) at the board production process or (c) which are applied partly or totally separately during various stages of the board production process.

In a further aspect, the present invention provides a method for a production process of forming a particle or MDF board satisfying at least one of (i) the EN standards EN 312 or EN 622-5, respectively, or (ii) the physical properties of JIS A 5905 and 5908, respectively, wherein the boards made according the first production process further satisfy at least one of
(1) the formaldehyde emission specification according to JIS A 5905 and 5908, respectively exceeding the limit of 0.3 mg/l when tested according to the Desiccator Test JIS A 1460, or
(2) a maximum formaldehyde emission of more 0.03 ppm when tested in the climate chamber test according to EN 717-1,
   and wherein the boards as produced by said second production process satisfy
(a) the F**** specification according to JIS A 5905 and 5908, respectively, by satisfying the limit of 0.3 mg/l or less when tested according to the Desiccator Test JIS A 1460, or
(b) a maximum formaldehyde emission of 0.03 ppm or less in the climate chamber test according to EN 717-1,
and wherein said first and said second production processes are essentially identical and comprise the use of an aminoplastic resin,
   said method of modifying the process comprises the step of
(a) adjusting the melamine level of said aminoplastic resin to more than 0% and less than 15%, wherein
(a1) the molar ratio of F/(NH₂)₂ is more than 0.70, preferably more than 0.80, and still more preferably more than 0.85, and less than 1.05 and preferably less than 1.00, if said resin comprises more than 0% of melamine; or
(b) formulating said aminoplastic resin essentially free of melamine, wherein
(b1) the molar ratio of F/U is more than 0.85, preferably more than 0.90, and still more preferably more than 0.95, when urea is the only NH₂-group containing raw material for said aminoplastic resin, or wherein
(b2) the molar ratio of F/(NH₂)₂ is more than 0.85, preferably more than 0.90, and still more preferably more than 0.95, when urea as well as other NH₂-group containing raw materials like ammonia are used as raw materials for said aminoplastic resin;
wherein the solids content of said aminoplastic resin is more than 66% but not more than 74% on a dry basis when said aminoplastic resin is applied in a core layer.

The present invention provides, in another aspect, a method for modifying a process according to paragraph 64, above, wherein the production process comprises the steps of applying the first adhesive composition to the one core layer in case of a three layer board or also to several core layers in case of multilayer boards of said board, and where the second adhesive composition but differing from said first adhesive composition is applied to the surface layers of said board.

Another aspect of the present invention is the use of chemicals sprayed onto the two surfaces. By choice, spraying can be done before the hot press cycle or onto the pressed boards. Spraying before the hot press process can be done by a spraying process onto the lower surface of the mat, effected by spraying onto the form belt before the mat forming station, whereas the spraying process onto the upper surface (top spray) is performed after the forming station just before the entrance of the hot press of the continuous line or the single opening press or before the loading station of a multi-opening press. Spraying onto the two surfaces of the boards after the hot press cycle can be done still on the hot boards before the star cooler. Another option can be to spray onto the two surfaces of the still warm boards after the star cooler, but in any case before hot stacking.

The adhesive system used in the core layer of particleboards is responsible for the mechanical strength of the boards in sense of internal bond and screw withdrawal strength, but also for the thickness swelling as well as partly for the bending strength. Based on existing technology of production of wood based panels, it is known that the water household of the core layer can be particularly critical in terms of a high moisture content of the particles after resination but still before the press. Higher moisture contents of the glued particles can cause high steam pressures in the hot press at the end of the hot press cycle. This can weaken the bond strength between the strictural elements (particles, fibres) in the board and/or can cause increased or even exceeding spring back of the board when the press opens or when the board leaves the continuous press or even can lead to blisters and delaminations, when the steam pressure at the moment of the opening of the press or at the end of the continuous press clearly exceeds the in situ bond strength of the still hot board.

It therefore is important to have a strong core layer adhesive system to avoid these disadvantages. Usually this can be achieved by selecting a proper adhesive core layer system, e.g. one that gives a quicker formation of the bond strength as well a higher ultimate bond strength due to better cross-linking. Both effects can be achieved by using a core layer resin system with a higher content of formaldehyde, without exceeding the stringent limitations concerning the subsequent formaldehyde emission, because the face layer of the board controls formaldehyde emissions.

The term “surface/face layer” in this context means the usual face layer in three layer particleboard or in a three layer MDF but also the “outer layer” of a single layer MDF; even single layer MDFs consist of the same fibre material blended (in which way ever, if blow line blended or by any of the various mechanical blending processes) and formed throughout the whole thickness of the board, an outer layer of such a single layer MDF can still be achieved with different properties from the inner layer of the same board e.g. by spraying water and chemicals before the press, in that way creating a “quasi three layer board” as described herein below. Unless not specified separately, the term “three layer boards” shall include so-called multilayer boards with e.g. two different face layers and/or a double core layer.

In three layer or multilayer boards, it is possible to adjust the composition of the various layers according to the special needs, as it is described also herein. The core layer in a three layer board or the various core layers in a multilayer board should have rather low moisture content in order to enhance the warming up of the mat during the hot press cycle by an increased steam shock effect. This has been discussed in detail herein above in the context of Table 2. This effect also is true for three layer MDF boards. However, conventional MDF boards consist typically essentially of only one layer with essentially identical composition of the material throughout the whole mat and hence the whole board after the hot press process. In these one layer MDF boards, only one resin can be used in blending, even though this one resin can be a mixture of several components which are mixed during resin production or which are mixed in course of the board production or even might be applied separately during the blending process. This latter case can be effectuated when having at least two independent nozzles for spraying the resin onto the fibres or when spraying one resin onto the fibres in the so-called blow line, and another equal, similar, or different resin via a so-called mechanical fibre blender, whereby all these process steps are well known in industry. However, all these executions experience the disadvantage that after forming and after pressing the mat to the final board during the hot press process, one uniform board with equal distribution exists throughout the whole cross section of the board.

Surprisingly, it had now been found that even in a one-layer particle or MDF board “quasi three layer behaviour” can be achieved by multifunctional surface treatment with suitable chemicals and compounds. This multifunctional surface treatment can be effected by various application technologies, like spraying to mention just one example but not limiting to this. Thus, applying or modifying the resins appropriately can also result for such “quasi three layer boards” with the advantageous properties.

It has now been surprisingly found that a lower formaldehyde content in the face/outer/surface layer can decrease the effective subsequent formaldehyde emission of boards, preferably MDF and particleboards, according to, for instance, the above-mentioned Japanese F**** standards as measured in a climate chamber or by the so-called desiccator test in Japan (according to JIS A 1460). This is a most remarkable result and finding, which gives surprising results when tested in reality.

Based on this surprising finding, it is possible to retain a core layer with a higher content of formaldehyde, hence giving higher press speed and shorter press times and still good board properties. The adjustment of the formaldehyde content in the core layer resin to be higher than in the face layer resin can be achieved in a typical three layer particleboard production. It can be done by selecting different adhesive resins for the two layers, whereby the difference can be the content of formaldehyde in the two resins, but also a different composition of the two resin mixes, with e.g. the addition of a formaldehyde scavenger in the surface layer or by the higher addition of catcher in the surface layer, if both layers contain scavenging chemicals. Any loss in reactivity in a surface layer resin of lower formaldehyde content is of minor importance because the energy input to the surface layer is big enough to guarantee proper hardening of the surface layer adhesive system during the press cycle.

Scavengers useful in the surface layer resins of the present invention include urea, non-monomeric chemicals containing urea or any other nitrogen containing molecule. It can further comprise ammonium salts, for instance ammonium nitrate and ammonium sulphate. The amounts of scavengers required can be from 0.1% to 35%, more preferably from 0.5% to 20% based on resin solids.

Still another important feature of the present invention is the use of a proper amount of a so-called hardener, as they the broadly used, e.g. ammonium salts, and preferably, this shall be done in combination with an acidic component in the hardener formulation, like an inorganic or organic acid.

Appropriate ammonium salts for this purpose include ammonium nitrate, ammonium sulphate and ammonium chloride. Appropriate acids include sulphuric acid, nitric acid, hydrochloric acid, formic acid, acetic acid, suphamic acid, citric acid, lactic acid and malic acid, which could be added as a liquid at a stock concentration of 10-85% and an addition rate of between 0.1 and 10%, more preferably between 0.5 and 4%.

The direct addition of the acid promotes the acidic hardening reaction and hence shortens the gel time. The addition of an acid decreases immediately the pH values of the aminoplastic resin and hence results in faster hardening compared to pure ammonium salts as hardeners, which still need to generate the acid for starting the hardening process. For formaldehyde based condensation resins this reaction of the ammonium salt hardener is restricted by the low availability of free formaldehyde in the resin. Even though the content of free formaldehyde in the liquid resin increases at higher temperatures in the hot press, the available free formaldehyde remains as the rate determining parameter. Contrary to this, the direct addition of a certain amount of acid provides acidic hydrogen ions directly, without the necessity for a temperature controlled reaction of the ammonium salt with the free formaldehyde. To avoid an uncontrolled pre-curing reaction before the start of the hot press cycle or before the mat enters the hot press, the type and the amount of added acid must be selected carefully.

In order to reduce the moisture content of the resinated particles in the core layer a particular aspect of the present invention is the increase of the solids content of the liquid adhesive, such as by adding suitable powdered resins to the liquid adhesive. This higher solid content also might be achieved by special cooking procedures and/or by evaporation of the liquid adhesive mix during or after the resin production. These special cooking procedures as such are known to a skilled person. In the context of the present invention, the increased solid content of the resins is important in terms of the reduction or at least the avoidance of increase of the moisture content of the glued particles, which is favourable for a quick heating up of the core layer by the so-called steam shock.

The solids content of conventional aminoplastic resin is typically in the range of 65 to 66%, measured by the so-called dish method at 120° C. for 120 minutes, a method well known and commonly used in industry. The solids content of the aminoplastic resins particularly useful in the context of the present invention when used as core layer resin in three layer boards or in one of the core layers in multilayer boards for both, particleboard and MDF should be more than 64%, alternatively more than 66%, preferably more than 68%, still more preferably more than 69%, and less than 74%, preferably less than 72%, and even more preferably less than 70%.

The results show that higher resin solids significantly reduce the values for the moisture content of the core layer, which on the other side enables a higher moisture content in the face in order to get a stronger steam effect and a quicker warming up of the core layer, without running into problems with possible too high steam pressures at the end of the press time and into possible steam blisters. Other components beyond those mentioned above can be added to the core layer or face layer and to the adhesive systems used in these two layers such as a certain amount of an isocyanate based adhesive in order to increase the degree of crosslinking in the hardened resin network.

### 3. EXAMPLES

The following examples describe embodiments according to the present inventions as well as comparative examples.

Resins according to the invention are prepared as shown in Table 2 with calculated moisture contents of glued core layer particles, based on a moisture content of the dried particles of 2% and a hardener addition as a 52% ammonium nitrate solution of 3.0% hardener solid on solid resin, not considering any other addition of chemicals throughout these examples.

TABLE 2
Calculated moisture contents of glued core layer particles

| | Resin consumption (% resin | |
|---|---|---|
| Resin solids | solids based on absolutely | Moisture |
| content (%) | dry particles) | content (%) |
| 66 | 8 | 5.9 |
| 66 | 9 | 6.3 |
| 68 | 8 | 5.5 |
| 68 | 9 | 5.9 |
| 70 | 8 | 5.2 |
| 70 | 9 | 5.6 |
| 72 | 8 | 4.9 |
| 72 | 9 | 5.3 |

### Example 1

### Production of an Improved F**** Particleboard, Using a Straight UF Resin As Adhesive in the Core Layer and a Melamine Fortified UF Resin in the Face Layer, According to the Invention

Resins in accordance with the present invention were prepared as discussed above, and the mUF resin at 68% solids, hardener and scavenger were applied to chips for the surface layer; while UF resin at 66% solids, hardener and scavenger were applied to the chips for core layer. A three layer 14 mm thick particle board was composed with the ratio between surface and core material of 3:4. The results in the Table 3 show that low emission of formaldehyde can be obtained at specific press time of 4.8 s/mm.

TABLE 3
Example 1

| | Core layer | Face layer |
|---|---|---|
| Resin type | UF (molar ratio F/U = | melamine fortified |
| | 0.94) | UF (5% melamine |
| | | based on liquid |
| | | resin, molar ratio |
| | | N/(NH₂)₂ = 0.85) |
| Resin loading (% resin solids based on dry | 7.5 | 11 |
| particles) | | |
| Addition of hardener (solid hardener based | 3.0 | 1.0 |
| on solid resin) NH₄NO₃ | | |
| Total molar ratio including all | 0.86 | 0.82 |
| amino/ammonium groups of the resin, | | |
| formaldehyde catcher and hardener | | |

| | |
|---|---|
| Specific press time (continuous press) | 4.8 s/mm |
| Perforator value according to EN 120 | 4 mg/100 g |
| Desiccator value according to JIS A1460 | 0.27 mg/l |

### Example 2

### Production of F**** Particle Board, Using Two Different MUF Resins as Adhesives for Core and Face Layer, According to a Formulation and Resulting in Properties as Per Table 4

TABLE 4
Example 2

| | Core layer | Face layer |
|---|---|---|
| Resin type | MUF | MUF |
| Resin loading (% resin solids based on dry | 12 | 12 |
| particles) | | |
| Addition of hardener: NH₄NO₃ (50%)(solid | 3 | 1 |
| hardener based on solid resin) | | |

| | |
|---|---|
| Specific press time (continuous press) | 5.8 s/mm |
| Perforator value according to EN 120 | 2 mg/100 g |
| Desiccator value according to JIS A1460 | 0.164 mg/l |

### Example 3

### Production of F**** Particleboards, Using One Melamine Fortified UF Resin as Adhesive in Core, and Straight UF Resin as Adhesive in Face Layer, According to a Formulation and Resulting in Properties as Per Table 5

TABLE 5
Comparative Example 3

| | Core layer | Face layer |
|---|---|---|
| Resin type | MUF | UF |
| Resin loading (% resin solids based on dry | 12 | 12 |
| particles) | | |
| Addition of hardener: NH₄NO₃ (50%)(solid | 3 | 1 |
| hardener based on solid resin) | | |

| | |
|---|---|
| Specific press time (continuous press) | 5.8 s/mm |
| Perforator value according to EN 120 | 1.7 mg/100 g |
| Desiccator value according to JIS A1460 | 0.160 mg/l |

### Example 4

### Production of a F**** PB, Using a Straight UF Resin as Adhesive in Core and Melamine Fortified UF Resin as Adhesive in Face layer, According to a Formulation and Resulting in Properties as Per Table 6

TABLE 7
Example 6

| | Core layer | Face layer |
|---|---|---|
| Resin type | UF | MUF |
| Resin loading (% resin solids based on dry | 12 | 12 |
| particles) | | |
| Addition of hardener: NH₄NO₃ (50%)(solid | 3 | 1 |
| hardener based on solid resin) | | |

| | |
|---|---|
| Specific press time (continuous press) | 5.8 s/mm |
| Perforator value according to EN 120 | 1.8 mg/100 g |
| Desiccator value according to JIS A1460 | 0.158 mg/l |

### Comparative Example 1

### Production of E1 Particleboards, Using a Straight UF Resin as Adhesive, According to a Formulation and Resulting in Properties as Per Table 7

TABLE 7
Comparative Example 1

| | Core layer | Face layer |
|---|---|---|
| Resin type | UF | UF |
| Resin loading (% resin solids based on dry | 12 | 12 |
| particles) | | |
| Addition of hardener NH₄NO₃ (50%) | 3 | 1 |
| (solid hardener on solid resin) | | |

| | |
|---|---|
| Specific press time (continuous press) | 5.8 s/mm |
| Perforator value according to EN 120 | 5.9 mg/100 g |
| Desiccator value according to JIS A1460 | 0.67 mg/l |

1. A multilayer low formaldehyde emission board comprising:
A) a core layer comprising a first adhesive composition, and
B) a face layer comprising a second adhesive composition;
wherein
1) each of said first and second adhesive compositions comprises an aminoplastic resin that has a dry base composition comprising between 0 and 15% melamine, and
2) said aminoplastic resin has a formaldehyde:NH₂ molar ratio (F/(NH₂)₂) of:
a) between 0.60 and 1.15 when said resin comprises melamine, or
b) greater than 0.85 when said resin is essentially free of melamine and when said resin comprises urea as well as other NH₂ containing components, and
3) said aminoplastic resin has a formaldehyde:urea molar ratio (F/U) of more than 0.85 when said resin is essentially free of melamine and comprises urea as the only NH₂ component;
4) said board emits:
a) 0.5 mg/ml or less formaldehyde as measured in a Desiccator Test JIS A 1460, or
b) 0.04 ppm or less formaldehyde as measured in an EN 717-1 climate chamber, and
5) said first and second adhesive compositions are not the same.

2. A multilayer low formaldehyde emission board comprising:
A) a core layer comprising a first adhesive composition, and
B) a face layer comprising a second adhesive composition;
wherein
1) each of said first and second adhesive compositions comprises an aminoplastic resin that has a dry base composition comprising between 0 and 15% melamine, and
2) the aminoplastic resin of said first adhesive composition:
i) has a formaldehyde:NH₂ molar ratio (F/(NH₂)₂) of:
a) between 0.70 and 1.05 when said resin comprises melamine, or
b) greater than 0.85 when said resin is essentially free of melamine and when said resin comprises urea as well as other NH₂ containing components, and
iii) has a formaldehyde:urea molar ratio (F/U) of more than 0.85 when said resin is essentially free of melamine and comprises urea as the only NH₂ component, and
3) the aminoplastic resin of said second adhesive composition has:
iii) a formaldehyde:NH₂ molar ratio (F/(NH₂)₂) of:
a) between 0.6 and 0.9, when said resin comprises up to 15% melamine, or
b) greater than 0.65 when said resin is essentially free of melamine and when said resin comprises urea as well as other NH₂ containing components, and
iv) a formaldehyde:urea molar ratio (F/U) of more than 0.60 when said resin is essentially free of melamine and comprises urea as the only NH₂ component, and
4) said board emits:
a) 0.5 mg/ml or less formaldehyde as measured in a Desiccator Test JIS A 1460, or
b) 0.04 ppm or less formaldehyde as measured in an EN 717-1 climate chamber, and
5) said first and second adhesive compositions are not the same.

3. The low formaldehyde emission board of claim 1 or 2, wherein said board emits:
a) 0.3 mg/ml or less formaldehyde as measured in a Desiccator Test JIS A 1460, or
b) 0.03 ppm or less formaldehyde as measured in an EN 717-1 climate chamber.

4. The low formaldehyde emission board of claim 1 or 2, wherein said board comprises at least one member selected from the group consisting of wood fibres, wood chips and wood strands.

5. The low formaldehyde emission board of claim 1 or 2, wherein said board is particle board or MDF.

6. The low formaldehyde emission board of claim 1 or 2, wherein said aminoplastic resin or glue mix when applied to the board comprises a solid content of between 64% and 76%.

7. The low formaldehyde emission board of claim 1 or 2, wherein said aminoplastic resin comprises a solid content when applied to the board of more than 64%.

8. The low formaldehyde emission board of claim 1 or 2, wherein said core layer comprises at least one member selected from the group consisting of an ammonium salt, an organic acid and an inorganic acid.

9. The low formaldehyde emission board of claim 1 or 2, wherein said first adhesive, said second adhesive or both comprise at least one catcher or scavenger selected from the group consisting of urea, a condensated chemical structure based on urea and nitrogen.

10. The low formaldehyde emission board of claim 1 or 2, wherein said aminoplastic resin is a curable aldehyde comprising formaldehyde, urea or mixtures thereof.

11. The low formaldehyde emission board of claim 1 or 2, wherein said aminoplastic resin comprises two or more components that are mixed during the resin production or at the board production process.

12. The low formaldehyde emission board of claim 1 or 2, wherein said aminoplastic resin comprises two or more components that are added and applied either partly separately or totally separately during the board production process.

13. The low formaldehyde emission board according to claims 1 or 2, further comprising at least one catcher or scavenger; said catcher or scavenger being urea or condensated chemical strictures based on urea, or a compound being able to react with formaldehyde, preferably containing nitrogen.

14. The low formaldehyde emission board according to claims 1 or 2, wherein said aminoplastic resin is characterized by at least one of the following:
(a) being a curable aldehyde condensation resin, comprising formaldehyde, preferably further comprising melamine, urea, or mixtures thereof,
(b) being composed of two or more components, mixed during the resin production;
(c) being composed of two or more components, mixed at the board production process;
(d) being composed of two or more components, added and applied partly or totally separately during the board production process.

15. A low formaldehyde emission particle or MDF board according to claims 1 or 2, satisfying at least one of
(i) the EN standards EN 312 or EN 622-5, respectively,
(ii) the physical properties of JIS A 5905 and 5908, respectively,
and further satisfying at least one of
(1) the formaldehyde emission specification according to JIS A 5905 and 5908, respectively, by satisfying the limit of 0.3 mg/l or less when tested according to the Desiccator Test JIS A 1460, or
(2) a maximum formaldehyde emission of 0.03 ppm or less when tested in the climate chamber test according to EN 717-1.

16. A low formaldehyde emission particle board according to claim 1, wherein said first adhesive composition comprises an aminoplastic resin, which is essentially free of melamine.

17. A low formaldehyde emission particle or MDF board according to claim 1, wherein said core layer comprises an aminoplastic resin having a solids content on a dry basis of more than 64%, preferably more than 68%, and less than 76%, preferably less than 72%.

18. A process for producing a board according to claim 1, wherein
a catcher or scavenger is liquid applied to the board,
said catcher or scavenger preferably being urea or condensated chemical structures based on urea, or any other chemical compound being able to react with formaldehyde, preferably containing nitrogen;

19. A process for producing a board according to claim 18, wherein said catcher or scavenger is applied to the surfaces before and/or after a mat forming step.

20. A process for producing a board according to claim 1, wherein
said first and/or said second adhesive composition are composed of two or more components, which are
(a) mixed during the resin production or
(b) at the board production process or
(c) which are applied partly or totally separately during various stages of the board production process.

21. A method for modifying first production process to a second production process of forming a particle or MDF board satisfying at least one of
(i) the EN standards EN 312 or EN 622-5, respectively,
(ii) the physical properties of JIS A 5905 and 5908, respectively,
wherein the boards made according the first production process further satisfy at least one of
(1) the formaldehyde emission specification according to JIS A 5905 and 5908, respectively exceeding the limit of 0.3 mg/l when tested according to the Desiccator Test JIS A 1460, or
(2) a maximum formaldehyde emission of more 0.03 ppm when tested in the climate chamber test according to EN 717-1,
and wherein the boards as produced by said second production process satisfy
(a) the F**** specification according to JIS A 5905 and 5908, respectively, by satisfying the limit of 0.3 mg/l or less when tested according to the Desiccator Test JIS A 1460, or
(b) a maximum formaldehyde emission of 0.03 ppm or less in the climate chamber test according to EN 717-1,
and wherein said first and said second production processes are essentially identical and comprise the use of an aminoplastic resin,
said method of modifying the process comprises the step of
(a) adjusting the melamine level of said aminoplastic resin to more than 0% and less than 15%, wherein
(a1) the molar ratio of F/(NH₂)₂ is more than 0.70, preferably more than 0.80, and still more preferably more than 0.85, and less than 1.05 and preferably less than 1.00, if said resin comprises more than 0% of melamine; or
(b) formulating said aminoplastic resin essentially free of melamine, wherein
(b1) the molar ratio of F/U is more than 0.85, preferably more than 0.90, and still more preferably more than 0.95, when urea is the only NH₂-group containing raw material for said aminoplastic resin, or wherein
(b2) the molar ratio of F/(NH₂)₂ is more than 0.85, preferably more than 0.90, and still more preferably more than 0.95, when urea as well as other NH₂-group containing raw materials like ammonia are used as raw materials for said aminoplastic resin;
wherein the solids content of said aminoplastic resin is more than 66% but not more than 74% on a dry basis when said aminoplastic resin is applied in a core layer.

22. A method for modifying a process according to claim 21, wherein the second production process comprises the steps of applying the first adhesive composition to the one core layer in case of a three layer board or also to several core layers in case of multilayer boards of said board, and where the second adhesive composition but differing from said first adhesive composition is applied to the surface layers of said board.
